(19) United States
(12) Patent Application Publication
(10) Pub. No.: US 2008/0047003 A1
(43) Pub. Date: Feb. 21, 2008

(54) Audit system

(75) Inventors: Daniel M. Wong, Sacramento, CA (US); Gopal B. Mulagund, Bangalore (IN)

Correspondence Address: Kraguljac & Kalnay, LLC, 4700 Rockside Road, Summit One, Suite 510, Independence, OH, 44131, US

(73) Assignee: Oracle International Corporation, Redwood Shores, CA (US)

(21) Appl. No.: 11/497,765

(22) Filed: Aug. 2, 2006

(51) Int. Cl. H04L 9/32

(52) U.S. Cl. 726/20

(57) ABSTRACT

Systems, methodologies, media, and other embodiments associated with storage of audit information. One system embodiment includes an audit memory configured to temporarily store audit information associated with a user request, an audit logic configured to store the audit information in the audit memory while the user request is processed; and, an audit storage logic configured to store the audit information stored in the audit memory in an audit store before a response is provided to the user request.

### BACKGROUND

Computer systems store information (e.g., data and/or files), some of which can be confidential and/or sensitive. Audit systems are used to collect and store audit information regarding individuals and/or entities that accessed the confidential and/or sensitive information.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates one embodiment of an example audit system.

FIG. 2 illustrates one embodiment of an example database audit system.

FIG. 3 illustrates one embodiment of an example file audit system.

FIG. 4 illustrates one embodiment of an example method for handling and storing audit information.

FIG. 5 illustrates an embodiment of another example method for processing audit information.

FIG. 6 further illustrates the example method of FIG. 5.

FIG. 7 illustrates one embodiment of another example method for processing audit information.

FIG. 8 further illustrates the example method of FIG. 7.

FIG. 9 illustrates one embodiment of another example method for processing audit information.

FIG. 10 illustrates one embodiment of an example computing environment in which example systems and methods illustrates herein can operate.

### DETAILED DESCRIPTION

Example systems, methods, computer-readable media, software and other embodiments are described herein that relate to storage of audit information. Audit information can include, for example, a user name/identifier, computer identifier, date, time, information accessed, privilege level, etc.

In one embodiment, audit information can be temporarily stored in an audit memory by an audit logic while a user request (e.g., database transaction and/or web server file interaction) is processed. The audit information is transferred to an audit store (e.g., audit log) by an audit storage logic. In one example, the transfer is completed prior to control being returned to the user (e.g., response provided to user request).

In one embodiment, the audit storage logic is an agent that acts substantially in parallel with the audit logic. That is, as audit information is stored in the audit memory by the audit logic, the audit storage logic can transfer the audit information to the audit store. For example, the audit logic and the audit storage logic can be computer components running simultaneously (e.g., with the audit logic having a higher processing priority). Those skilled in the art will recognize that the audit storage logic can work in conjunction with other existing audit system(s) where audit records are written directly to the audit store.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation, like that generated during radio-wave and infrared data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

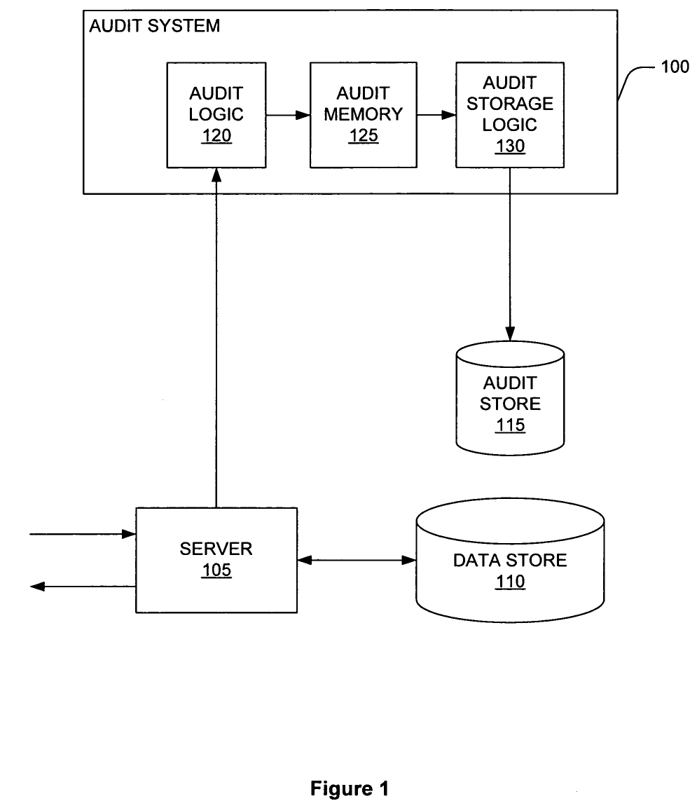

FIG. 1 illustrates one embodiment of an example audit system 100. A server 105 (e.g., database server and/or web server) receives a user request (e.g., database transaction and/or file system interaction) associated with a data store 110. During processing of the user request, the server 105 provides audit information to the audit system 100.

The audit system 100 can store audit information in an audit store 115. The audit information can include, for example, a user name/identifier, computer identifier, date, time, information accessed, privilege level, etc. associated with the user request. The stored audit information can be employed, for example, to record access to sensitive information, to discover suspicious activity, and/or to identify potential security threats and the like.

A user request can comprise one or a plurality of autonomous transaction(s). With conventional audit systems, audit information associated with each autonomous transaction of a user request is recorded directly into an audit store (e.g., audit log). Due to delays associated with storage devices (e.g., disk drives) and processing overhead, conventional audit systems can negatively impact overall system speed.

The audit system 100 includes an audit logic 120 configured to temporarily store audit information associated with a user request (e.g., database transaction and/or web server file interaction) in an audit memory 125. The audit information stored in the audit memory 125 is then stored (e.g., transferred) in an audit store 115 (e.g., audit log and/or file) by an audit storage logic 130. For example, the storing can be completed prior to control being returned to the user upon completion of the user request. In one embodiment, the audit storage logic 130 stores the audit information while the user request is processed.

Processing overhead associated with the audit memory 125 can be less than processing overhead associated with storage devices (e.g., disk drives). For example, accessing and storing data in a memory like cache memory is faster than accessing and storing data in a disk drive. Thus, by temporarily storing the audit information in the audit memory 125, delays associated with conventional audit systems can be reduced.

In one embodiment, the audit storage logic 130 (e.g., an agent) acts substantially in parallel with the audit logic 120. The audit logic 120 and the audit storage logic 130 can be computer components running simultaneously with the audit logic 120, where the audit logic 120 can be given a higher processing priority. As audit information is stored and accumulated in the audit memory 125 by the audit logic 120, the audit storage logic 130 can store the audit information in the audit store 115. For example, while the audit logic 120 is storing audit information associated with a second autonomous transaction (in the audit memory 125), the audit storage logic 130 can simultaneously transfer audit information associated with a first autonomous transaction previously stored by the audit logic 120.

In another embodiment, the audit logic 120 stores audit information about a user request in the audit memory 125 while the user request is processed. Once the user request has been processed, the audit information is then stored to the audit store 115 by the audit storage logic 130. In this manner, the audit storage logic 130 can take advantage of reduced processing overhead by performing a bulk transfer of information (e.g., direct path insertion and/or block write).

In yet another embodiment, the audit storage logic 130 transfers the audit information from the audit memory 125 to the audit store 115 once a threshold quantity of audit information has been stored in the audit memory 125. The threshold quantity can be based on a block transfer size associated with the audit store. For example, the audit store can be a file stored on a disk drive with a block transfer of 8 kilobytes. In order to reduce processing overhead, the audit storage logic 130 can delay transferring the audit information to the audit store until about 8 kilobytes of audit information has been stored by the audit logic 120. Of course, other data sizes can be implemented. However, in order to ensure that the audit information is transferred timely, in one example, any remaining audit information in the audit memory 125 is transferred to the audit store 115 prior to returning control back to the user.

In one embodiment, the user request (e.g., database transaction) comprises a plurality of autonomous transactions. In this example, each autonomous transaction can be selectively identified as audited or not audited. The audit logic 120 can store audit information associated with a particular autonomous transaction if the particular autonomous transaction is identified as being a transaction that is to be audited.

In another embodiment, the server logic can simultaneously process a plurality of user requests (e.g., from a plurality of users). In this example, the audit logic 120 can simultaneously store audit information associated with a plurality of user requests.

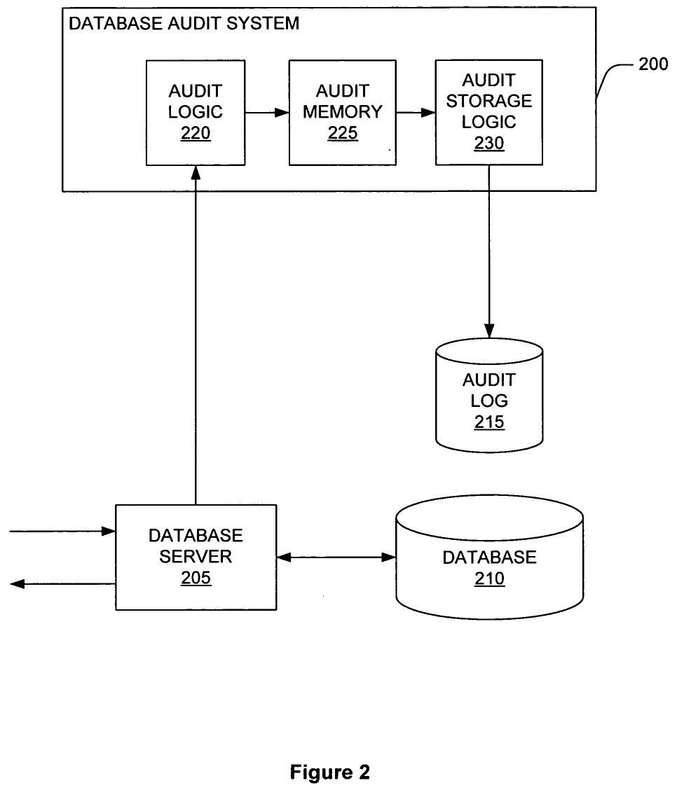

FIG. 2 illustrates one embodiment of an example database audit system 200. In one example, the database audit system 200 is configured to receive audit information from a database server 205 in response to the database sever 205 receiving and processing a database transaction request (e.g., from a user). The audit information includes information associated with the database transaction request. As previously mentioned, the audit information records activities that occur with selected databases (e.g. database 210) to keep track of accesses made to sensitive information, to discover suspicious activity, and/or to identify potential security threats and the like. The audit system 200 stores the audit information in an audit log 215 and an example description of the operations and components that can be involved are provided as follows.

The database audit system 200 includes an audit logic 220 configured to temporarily store audit information associated with the database transaction request in an audit memory 225. The audit information stored in the audit memory 225 is then transferred to the audit log 215 by an audit storage logic 230. The audit logic 220, the audit memory 225, and/or the audit storage logic 230 can be similar in configuration to the audit logic 120, the audit memory 125, and/or the audit storage logic 130, respectively, as described with reference to FIG. 1.

As noted previously, in one embodiment, the database transaction request can result in a plurality of autonomous database transactions being executed. Each autonomous database transaction can be selectively identified (e.g. previously flagged) as a transaction that is to be audited or not. The audit logic 220 can store audit information associated with a particular autonomous database transaction if the particular autonomous database transaction is identified as one to be audited.

In another embodiment, the server logic can simultaneously process a plurality of database transaction requests (e.g., from a plurality of users). In this example, the audit logic 220 can simultaneously store audit information associated with a plurality of user requests.

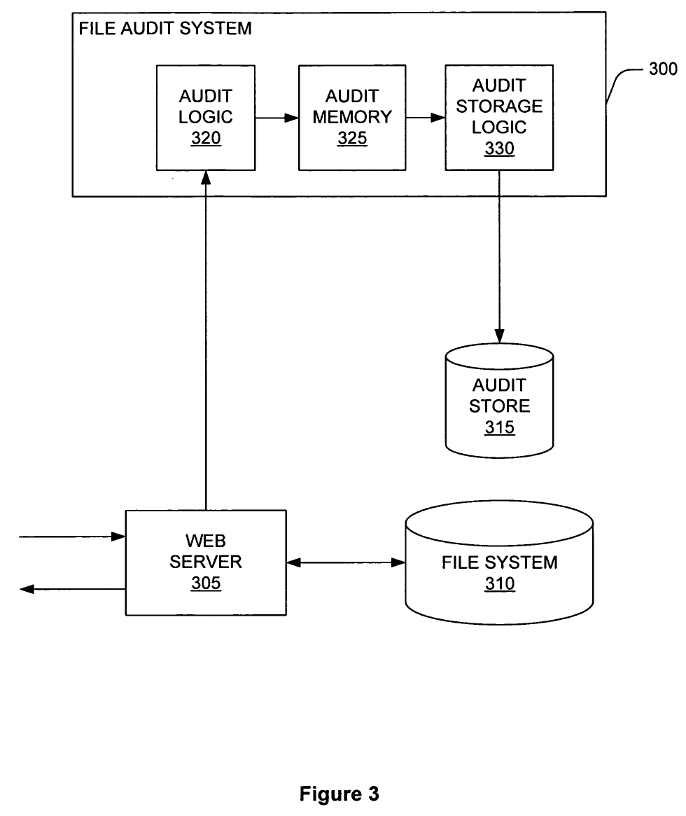

FIG. 3 illustrates one embodiment of an example file audit system 300. A web server 305 receives a file system 310 interaction request (e.g., from a user) and during processing of the request provides audit information to the file audit system 300. The file audit system 300 stores audit information in an audit store 315 (e.g., file).

The file audit system 300 includes an audit logic 320 configured to temporarily store audit information associated with the file interaction request in an audit memory 325. The audit information stored in the audit memory 325 can be transferred to the audit store 315 by an audit storage logic 330. The audit logic 320, the audit memory 325, and/or the audit storage logic 330 can be similar in configuration to the audit logic 120, the audit memory 125, and/or the audit storage logic 130, respectively, as described in FIG. 1 or similar components of FIG. 2.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that various actions could occur concurrently, substantially in parallel, and/or at substantially different points in time.

It will be appreciated that electronic and software applications may involve dynamic and flexible processes such that the illustrated blocks can be performed in other sequences different than the one shown and/or blocks may be combined or separated into multiple components. Blocks may also be performed concurrently, substantially in parallel, and/or at substantially different points in time. They may also be implemented using various programming approaches such as machine language, procedural, object oriented and/or artificial intelligence techniques. The foregoing applies to all methodologies described herein.

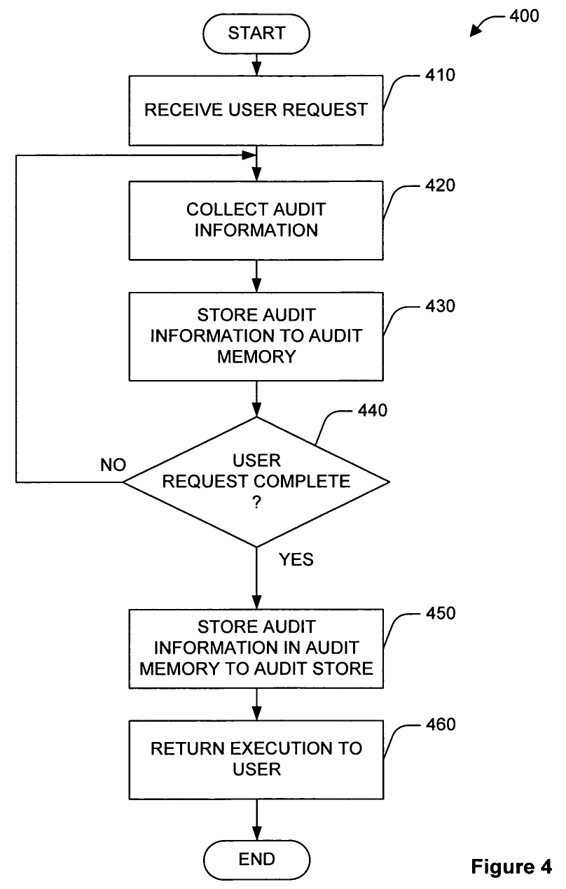

FIG. 4 illustrates a method 400 for handling and storing audit information. The method 400 will be described with reference to an example of processing a user request that involves accessing a data store. Furthermore, it can be presumed that accesses to the data store have been flagged to be audited. Of course, other types of requests and/or computer related transactions can be audited.

Referring now to FIG. 4, the method 400 can initiate, for example, at block 410 when a user request is received. As a result of the user request being processed by a computer system, a data store is accessed, which triggers audit information relating to the access to be collected. At 420, audit information is collected (e.g., associated with access of a data store based on the user request). At 430, the audit information is stored in an audit memory.

At 440, a determination is made as to whether the user request is complete (e.g., all autonomous transaction(s) completed). If the determination at 440 is NO, then the method returns to block 420 to collect additional audit information, if necessary. If the determination at 440 is YES, at 450, audit information in the audit memory is stored to an audit store. At 460, execution is returned to the user and the method 400 ends. It will be appreciated that storing the audit information in the audit memory can be regarded as a temporary storage of data into a low latency memory. Then, the audit data can be transferred (e.g. copied and/or moved) to the audit store, which can be a more permanent type of storage medium (e.g. a disk drive, CD, and the like).

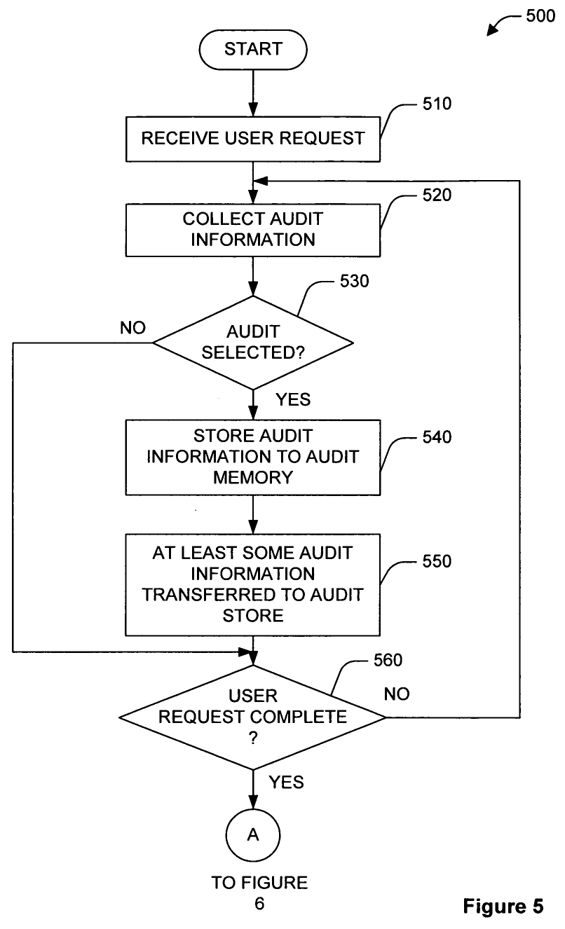

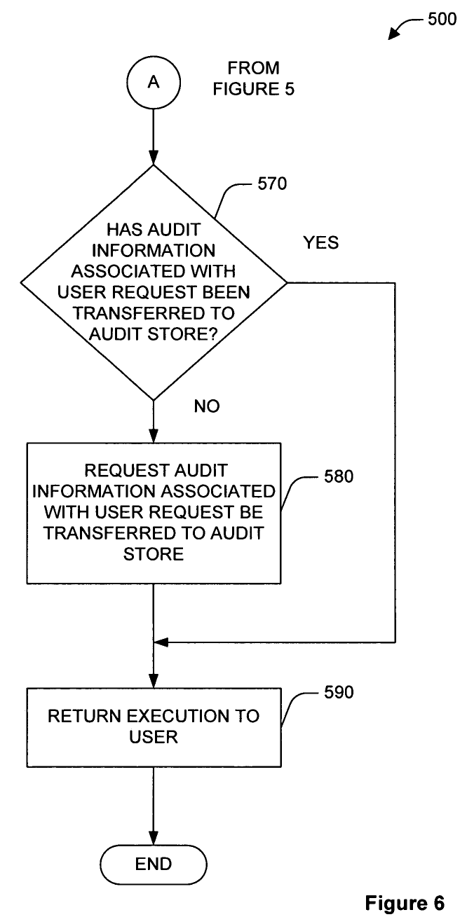

FIGS. 5 and 6 illustrate a method 500 for processing audit information. In this method 500, audit information is temporarily stored in an audit memory and transferred substantially in parallel to an audit store. Upon completion of processing of a user request, any audit information remaining in the audit memory is transferred to the audit store before execution is returned to the user.

The method 500 can initiate, for example, at 510, when a user request is received. At 520, audit information is collected (e.g., information associated with access of a data store or other designated location based on the user request).

Continuing, at 530, a determination is made as to whether audit has been selected (e.g., for a particular autonomous transaction associated with the user request). If the determination at 530 is NO, the method 500 continues at 560. If the determination at 530 is YES, at 540, audit information is stored to an audit memory. At 550, at least some of the audit information is transferred to an audit store. In one example, transferring of audit information occurs substantially in parallel with collection and/or storage of additional audit information.

At 560, a determination is made as to whether the user request is complete. If the determination at 560 is NO, the method 500 continues at 520.

If the determination at 560 is YES, at 570, a determination is made as to whether audit information associated with the user request has been transferred to the audit store. For example, if a block transfer mechanism is employed to transfer audit information from the audit memory to the audit store, any additional information not yet transferred would be left in the audit memory. If the determination at 570 is YES, the method 500 continues at 590. That is, the audit information has been transferred from the audit memory to the audit store and execution can be returned back to the user.

If the determination at 570 is NO, at 580, a request is made for the audit information associated with the user request to be transferred to the audit store. In one example, the request is issued and processing does not continue until confirmation is received as to completion of the transference of audit information from the audit memory to the audit store. At 590, execution returns to the user, and the method 500 ends.

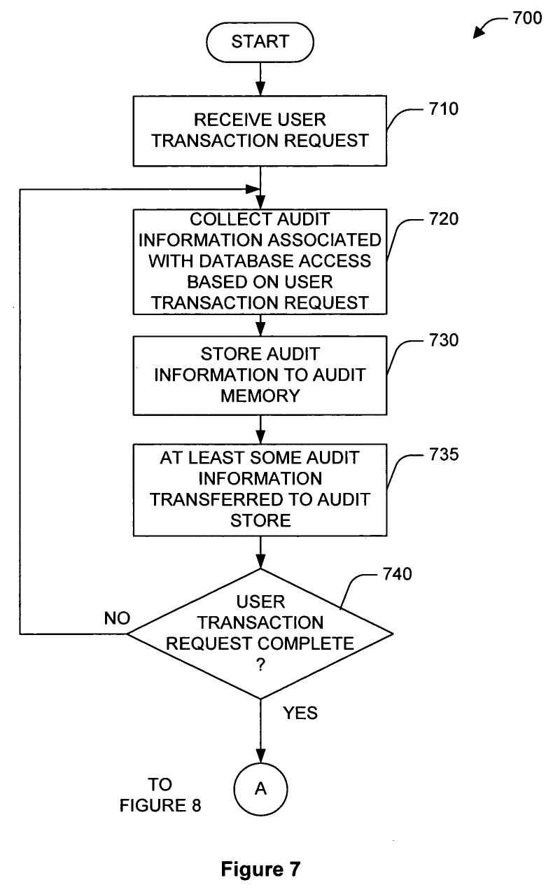

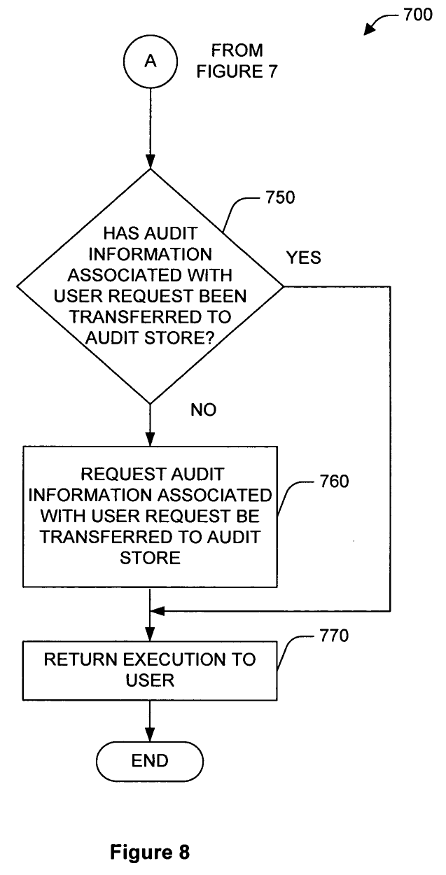

FIGS. 7 and 8 illustrate a method 700 for processing audit information. In the method 700, audit information associated with a user database transaction request is temporarily stored in an audit memory and transferred substantially in parallel to an audit store. Upon completion of processing of the user database transaction request, any audit information remaining in the audit memory is transferred to the audit store before execution is returned to the user. The details of method 700 can be as follows.

At 710, a user transaction request is received. For explanatory purposes, assume that the request causes a data access that has been flagged to be audited. At 720, audit information is collected. At 730, audit information associated with the access is stored in an audit memory. At 735, at least some audit information is transferred to an audit store. For example, an audit logic agent can transfer blocks of data between the audit memory and the audit store in order to optimize overall performance.

At 740, a determination is made as to whether the user transaction request is complete. If the determination at 740 is NO, the method 700 continues at 720. For example, a single user database transaction request can comprise tens, hundreds or even thousands of autonomous database transactions.

If the determination at 740 is YES, at 750, a determination is made as to whether audit information associated with the user request has been transferred to an audit store. If the determination at 750 is YES, the method 700 continues at 770. If the determination at 750 is NO, at 760, a request is made for audit information associated with the user request to be transferred to the audit store. As such, any audit information remaining in the audit memory is transferred to the audit store before control is returned to a user (e.g., before a response is provided to user transaction request). At 770, execution is returned to the user and the method 700 ends.

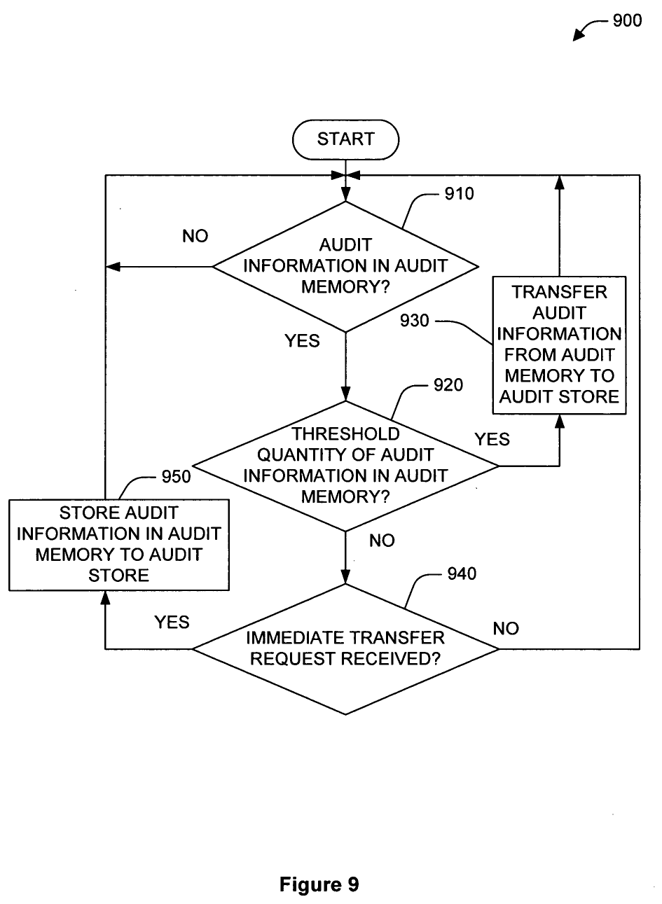

FIG. 9 illustrates a method 900 for processing audit information. In one embodiment, the method 900 can be employed by an audit storage logic acting as an agent. The method 900 monitors (e.g., polls) an audit memory to determine whether audit information has been stored. In order to optimize overall system performance, the method 900 can transfer the audit information to an audit store in blocks (e.g., threshold quantity of audit information). However, the method 900 can immediately transfer audit information to the audit store upon request, for example, received upon completion of processing of a user request (e.g., in order to ensure the transfer of audit information to the audit store prior to control of execution returning to a user).

The method 900 can initiate, for example, at 910, where a determination is made as to whether audit information has been stored in an audit memory. If the determination at 910 is NO, the method 900 continues at 910. Thus, the method 900 continues to poll the audit memory until audit information has been stored therein.

If the determination at 910 is YES, at 920 a determination is made as to whether a threshold quantity of audit information is stored in the audit memory. That is, audit information has been stored in the audit memory, but in order to optimize overall system performance, the method 900 delays transferring the audit information to an audit store until a threshold quantity of audit information has been received. If the determination at 920 is YES, at 930, the threshold quantity of audit information is stored in the audit store. And the method 900 continues at 910 as the audit memory has been cleared and the method 900 will continue to poll for additional audit information stored in the audit memory.

If the determination at 920 is NO, at 940, a determination is made as to whether an immediate transfer request has been received. The immediate transfer request can be associated with completion of processing of a user request, for example, to ensure the transfer of audit information to the audit store prior to control of execution returning to a user.

If the determination at 940 is NO, the method 900 continues at 910. If the determination at 940 is YES, at 950, audit information in the audit memory is stored in the audit store and the method 900 continues at 910.

While FIGS. 5-9 illustrate various actions occurring in serial, it is to be appreciated that various actions illustrated in FIGS. 5-9 could occur substantially in parallel. Further, in one example, methodologies are implemented as processor executable instructions and/or operations stored on a computer-readable medium.

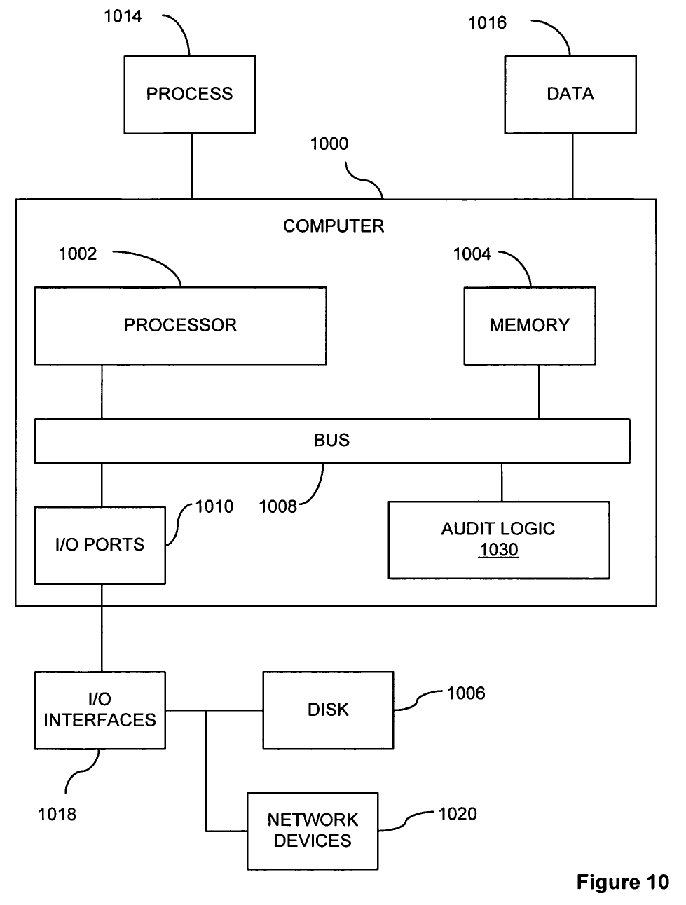

FIG. 10 illustrates an example computing device in which example systems and methods described herein, and equivalents, may operate. The example computing device may be a computer 1000 that includes a processor 1002, a memory 1004, and input/output ports 1010 operably connected by a bus 1008. In one example, computer 1000 may include an audit logic 1030 configured to facilitate storage of audit information. The audit logic 1030 can be implemented similar to the audit system 100 of FIG. 1, the database audit system 200 of FIG. 2, the file audit system 300 of FIG. 3, and/or implemented to perform one or more aspects of the methods shown in FIGS. 4-9. In different examples, logic 1030 may be implemented in hardware, software, firmware, and/or combinations thereof. Thus, logic 1030 may provide means (e.g., hardware, software, firmware) for storing audit information. While logic 1030 is illustrated as a hardware component attached to bus 1008, it is to be appreciated that in one example, logic 1030 could be implemented in processor 1002, implemented as executable instructions stored on a medium, or other type of computer component.

Generally describing an example configuration of computer 1000, processor 1002 may be a variety of various processors including dual microprocessor and other multi-processor architectures. Memory 1004 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM).

Disk 1006 may be operably connected to the computer 1000 via, for example, an input/output interface (e.g., card, device) 1018 and an input/output port 1010. Disk 1006 may be, for example, a magnetic disk drive, a solid state disk drive, a floppy disk drive, a tape drive, a Zip drive, a flash memory card, and/or a memory stick. Furthermore, disk 1006 may be a CD-ROM, a CD recordable drive (CD-R drive), a CD rewriteable drive (CD-RW drive), and/or a digital video ROM drive (DVD ROM). Memory 1004 can store processes 1014 and/or data 1016, for example. Disk 1006 and/or memory 1004 can store an operating system that controls and allocates resources of computer 1000.

Bus 1008 may be a single internal bus interconnect architecture and/or other bus or mesh architectures. While a single bus is illustrated, it is to be appreciated that computer 1000 may communicate with various devices, logics, and peripherals using other busses (e.g., PCIE, SATA, Infiniband, 1394, USB, Ethernet). Bus 1008 can be types including, for example, a memory bus, a memory controller, a peripheral bus, an external bus, a crossbar switch, and/or a local bus. The local bus may be, for example, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

Computer 1000 may interact with input/output devices via i/o interfaces 1018 and input/output ports 1010. Input/output devices may be, for example, a keyboard, a microphone, a pointing and selection device, cameras, video cards, displays, disk 1006, network devices 1020, and so on. Input/output ports 1010 may include, for example, serial ports, parallel ports, and USB ports.

Computer 1000 can operate in a network environment and thus may be connected to network devices 1020 via i/o interfaces 1018, and/or i/o ports 1010. Through the network devices 1020, computer 1000 may interact with a network. Through the network, computer 1000 may be logically connected to remote computers. Networks with which computer 1000 may interact include, but are not limited to, a local area network (LAN), a wide area network (WAN), and other networks. In different examples, network devices 1020 may connect to LAN technologies including, for example, fiber distributed data interface (FDDI), copper distributed data interface (CDDI), Ethernet (IEEE 802.3), token ring (IEEE 802.5), wireless computer communication (IEEE 802.11), and Bluetooth (IEEE 802.15.1). Similarly, network devices 1020 may connect to WAN technologies including, for example, point to point links, circuit switching networks (e.g., integrated services digital networks (ISDN)), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. An audit system, comprising:
an audit memory configured to temporarily store audit information associated with a user request;
an audit logic configured to store the audit information in the audit memory while the user request is processed; and,
an audit storage logic configured to transfer the audit information from the audit memory to an audit store before a response is provided to the user request.

2. The audit system of claim 1, where the audit storage logic is further configured to store the audit information substantially in parallel with the audit logic.

3. The audit system of claim 1, where the audit storage logic is further configured to store the audit information while the user request is processed.

4. The audit system of claim 1, where the audit storage logic is further configured to store the audit information once a threshold quantity of audit information has been stored in the audit memory.

5. The audit system of claim 1, where the user request is a database transaction.

6. The audit system of claim 5, where the database transaction comprises a plurality of autonomous transactions and for each autonomous transaction, the audit logic is further configured to store audit information associated with the autonomous transaction, only if the autonomous transaction is identified as audited.

7. The audit system of claim 1, where the user request is a web server file interaction.

8. The audit system of claim 1, where the audit logic is further configured to simultaneously store audit information associated with a plurality of user requests.

9. The audit system of claim 1, where the audit logic and the audit storage logic are computer components configured to run simultaneously.

10. The audit system of claim 9, where the audit logic is configured to have a higher processing priority than the audit storage logic.

11. A database audit system, comprising:
an audit memory configured to temporarily store audit information associated with a database transaction request;
an audit logic configured to store the audit information in the audit memory while the database transaction request is processed; and,
an audit storage logic configured to store the audit information stored in the audit memory in an audit log before a response is provided to the database transaction request, where the audit logic and the audit storage logic are configured to perform substantially in parallel.

12. The database audit system of claim 11, where the audit storage logic is further configured to store the audit information once a threshold quantity of information has been stored in the audit memory.

13. The database audit system of claim 11, where the database transaction comprises a plurality of autonomous transactions and for each autonomous transaction, the audit logic is further configured to store audit information only if the autonomous transaction is identified as audited.

14. The database audit system of claim 11, where the audit logic is further configured to simultaneously store audit information associated with a plurality of database transaction requests.

15. An audit system, comprising:
means for storing audit information related to a computer transaction in an audit memory while the computer transaction is processed; and,
means for transferring the audit information from the audit memory to an audit store, where the means for transferring completes transferring before control is returned to a user upon completion of the computer transaction.

16. The audit system of claim 15, where the means for storing audit information and the means for transferring audit information are configured to perform substantially in parallel.

17. The audit system of claim 15, where the user request comprises a plurality of autonomous transactions and for each autonomous transaction, the means for storing audit information is further configured to store audit information associated with the autonomous transaction, only if the autonomous transaction is identified as audited.

18. The audit system of claim 15, where the means for transferring audit information is configured to transfer the audit information once a threshold quantity of audit information has been stored in the audit memory.

19. A computer-readable medium for providing processor executable instructions for causing a computing device to perform a method for storing audit information, the method comprising:
accessing a data store based on a user request;
storing audit information associated with the access in an audit memory;
transferring the audit information in the audit memory to an audit store, where the transfer is completed prior to a response being provided to the user request.

20. The computer-readable medium of claim 19, where the user request is a database transaction.

21. The computer-readable medium of claim 19, where storing audit information associated with the access and transferring the audit information are performed substantially in parallel.

22. The computer-readable medium of claim 19, where storing audit information associated with the access is completed prior to transferring the audit information to the audit store.

23. A method for storing audit information, comprising:
transferring a threshold amount of audit information from an audit memory to an audit store, if a threshold amount of audit information is stored in the audit memory; and,
transferring audit information from the audit memory to the audit store, if a request for immediate transfer is received.

24. The method of claim 23 being implemented by processor executable instructions provided by a machine-readable medium.
